(19) United States
(12) Patent Application Publication
(10) Pub. No.: US 2025/0304489 A1
(43) Pub. Date: Oct. 2, 2025

(54) ELECTROCONDUCTIVE MATERIAL, CERAMIC ELECTRONIC COMPONENT, AND METHOD FOR PRODUCING THE SAME

(71) Applicant: Murata Manufacturing Co., Ltd., Nagaokakyo-shi (JP)

(72) Inventor: Toshihiko KOBAYASHI, Nagaokakyo-shi (JP)

(21) Appl. No.: 19/236,246

(22) Filed: Jun. 12, 2025

Related U.S. Application Data
(63) Continuation of application No. PCT/JP2023/043947, filed on Dec. 8, 2023.

(30) Foreign Application Priority Data
Dec. 20, 2022 (JP) 2022-202814

(51) Int. Cl. C03C 4/14; C03C 8/16; C04B 41/00; C04B 41/45; C04B 41/50; H01G 4/008; H01G 4/30

(52) U.S. Cl. CPC C03C 4/14; C03C 8/16; C04B 41/0072; C04B 41/009; C04B 41/4539; C04B 41/5022; H01G 4/0085; H01G 4/30; C03C 2209/00

(57) ABSTRACT

An electroconductive material includes CuO nanoparticles that, when fired, becomes metallic copper defining an electroconductive component, a glass raw material mixture that becomes glass when fired, and a solvent that dissolves or disperses the CuO nanoparticles and the glass raw material mixture. The glass raw material mixture includes a metal salt configured as powder with a particle diameter of about 100 nm or less or as ions. The electroconductive material is applied to the surface of the ceramic body and then fired at a temperature higher than or equal to the melting point of the glass raw material mixture to form the outer electrodes.

### CROSS REFERENCE TO RELATED APPLICATIONS

This application claims the benefit of priority to Japanese Patent Application No. 2022-202814 filed on Dec. 20, 2022 and is a continuation application of PCT Application No. PCT/JP2023/043947 filed on Dec. 8, 2023. The entire contents of each application are hereby incorporated herein by reference.

### BACKGROUND OF THE INVENTION

### 1. Field of the Invention

The present invention relates to electroconductive materials, ceramic electronic component production methods performed using electroconductive materials, and ceramic electronic components obtained using production methods.

### 2. Description of the Related Art

For example, Japanese Unexamined Patent Application Publication No. 2007-103845 describes an electroconductive paste for terminal electrodes of a laminated ceramic component, which is an electroconductive material of interest to the present invention. The electroconductive paste includes an electroconductive powder such as a copper powder, a glass powder, and an organic vehicle. When the glass powder used has a composition adjusted in order to improve acid resistance, even if the terminal electrodes of the laminated ceramic component are thin films, problems caused by the permeation of a plating solution, such as a reduction in the bonding strength of the terminal electrodes to a body of the laminated ceramic component and delamination of the terminal electrodes, are less likely to occur.

In Japanese Unexamined Patent Application Publication No. 2007-103845, the film thickness of the terminal electrodes formed as thin films is assumed to be about 20 μm, as described below. In examples of Japanese Unexamined Patent Application Publication No. 2007-103845, the particle diameter of the glass powder is 3.3 μm.

In a laminated ceramic component, it is necessary for the terminal electrodes to include glass in addition to the electroconductive metal component in order to ensure the denseness of the films and the adhesion to the body. The glass powder in the electroconductive paste forms the glass. The particles of the glass powder are fused together during firing performed to obtain the laminated ceramic component.

When the terminal electrodes are formed as thin films having a film thickness of, for example, 5 μm or less, the glass is significantly exposed at the surfaces of the outer electrodes due to the presence of the glass powder particles fused together, so that the continuity of the region in which the electroconductive metal is distributed deteriorates. In this case, plating adhesion may deteriorate in the step of plating the terminal electrodes. If the glass penetrates the terminal electrodes in the film thickness direction, the glass may dissolve in water. In this case, water permeation paths may be formed in the terminal electrodes.

### SUMMARY OF THE INVENTION

Example embodiments of the present invention each provide a technique for electroconductive films such as terminal electrodes on the surfaces of ceramic electronic components. As a result, even when the electroconductive films are reduced in thickness, the deterioration of plating adhesion and the formation of the water permeation paths described above are less likely to occur.

Example embodiments of the present invention each provide an electroconductive material to define an electroconductive film able to meet the demand that the deterioration of plating adhesion and the formation of water permeation paths are less likely to occur. Example embodiments of the present invention also each provide a ceramic electronic component production method in which a step of forming an electroconductive film is performed using the electroconductive material and also provide a ceramic electronic component produced using a production method.

Electroconductive materials according to example embodiments of the present invention are each used to form an electroconductive film through firing and includes CuO nanoparticles that, when fired, become metallic copper defining and functioning as an electroconductive component, a glass raw material mixture that becomes glass when fired, and a solvent that dissolves or disperses the CuO nanoparticles and the glass raw material mixture. The glass raw material mixture includes a metal salt configured as a powder with a particle diameter of about 100 nm or less or as ions.

An example embodiment of the present invention provides a method for producing a ceramic electronic component including a ceramic body and an electroconductive film on a surface of the ceramic body. The method includes applying the electroconductive material to a surface of the ceramic body to form the electroconductive film, heat-drying the glass raw material mixture included in the electroconductive material, and performing firing at a temperature higher than or equal to a melting point of the glass raw material mixture to thus form the electroconductive film.

An example embodiment of the present invention provides a ceramic electronic component including a ceramic body and an electroconductive film on a surface of the ceramic body. Ceramic electronic components according to example embodiments of the present invention have the following features.

The electroconductive film includes copper and glass. In a cross section of the electroconductive film taken in a thickness direction thereof, a plurality of glass domains including the glass, surrounded by the copper, and are not in contact with a surface and an underlayer in the cross section. An average of diameters of circles circumscribing the glass domains is about 0.5 μm or more and about 0.7 μm or less. A standard deviation of the diameters of the circles is about 0.3 μm or more and about 0.5 μm or less, and a ratio of a maximum diameter of the circles to a dimension of the electroconductive film in the thickness direction is less than about 1.

In each of example embodiments of the present invention, the ceramic electronic component obtained includes the electroconductive film in which the deterioration of plating adhesion and the formation of water permeation paths are unlikely to occur.

More specifically, in example embodiments of the present invention, the electroconductive material used to form the electroconductive film includes the CuO nanoparticles defining and functioning as the electroconductive component and the glass raw material mixture including a powder having a particle diameter of about 100 nm or less or defined ions. The electroconductive material is fired at a temperature higher than or equal to the melting point of the glass raw material mixture to form the electroconductive film.

Therefore, even when the glass particles are fused together in the firing step, the copper domains and the glass domains are able to remain small in size. In this case, in the cross section of the obtained electroconductive film that is taken in the thickness direction, the average of the diameters of circles circumscribing the glass domains that are not in contact with the surface and the underlayer and are surrounded by the metal is about 0.5 μm or more and about 0.7 μm or less, for example. The standard deviation of the diameters of the circles is about 0.3 μm or more and about 0.5 μm or less, and the ratio of the maximum diameter of the circles to the dimension of the electroconductive film in the thickness direction is less than about 1, for example.

In this electroconductive film, the copper defining and functioning as the electroconductive component and ceramic portions of the ceramic body are bonded by the glass, and the glass is provided so as to be separated from the copper and is dispersed as small domains of uniform size. Therefore, intrusion of moisture from glass portions on the surface of the electroconductive film can be reduced. Moreover, the glass is not exposed significantly present at the surface of the electroconductive film, so that good plating adhesion can be obtained.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 shows a cross-sectional view schematically illustrating a multilayer ceramic capacitor 1 according to an example embodiment of the present invention.

FIG. 2 shows an enlarged cross-sectional view schematically illustrating a portion of a first outer electrode 6 of the multilayer ceramic capacitor 1 shown in FIG. 1.

FIG. 3 shows an SEM image showing a cross-sectional structure of an electroconductive film used as outer electrodes 6 and 7 of the multilayer ceramic capacitor 1 shown in FIG. 1, the SEM image being taken in Experimental Examples and showing a cross section of a sample of an electroconductive film 12 in an Example of an example embodiment of the present invention.

FIG. 4 shows an enlarged SEM image of a portion of the electroconductive film 12 shown in FIG. 3.

FIG. 5 shows an image in which circles EC circumscribing glass domains 13 are added to the SEM image shown in FIG. 4.

FIG. 6 shows an SEM image of a cross section of a sample of an electroconductive film 22 in a Comparative Example, the SEM image being taken in the Experimental Examples.

### DETAILED DESCRIPTION OF THE EXAMPLE EMBODIMENTS

Example embodiments of the present invention will be described in detail below with reference to the drawings.

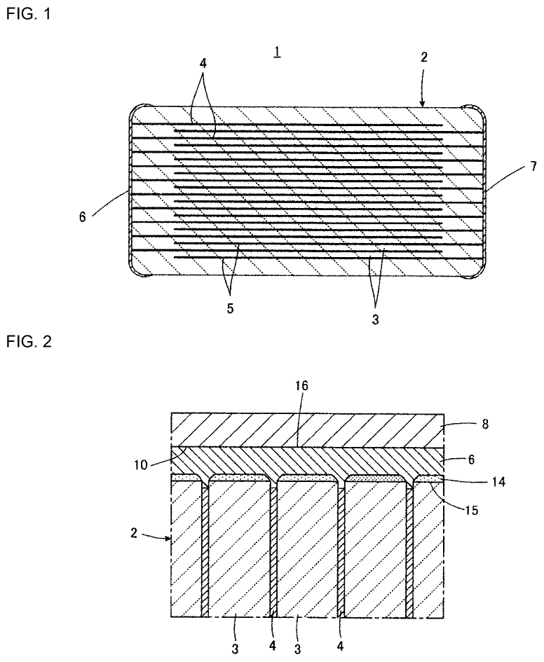

Referring to FIG. 1, the structure of a multilayer ceramic capacitor 1, which is a ceramic electronic component according to an example embodiment of the invention, will be described.

The multilayer ceramic capacitor 1 includes a ceramic body 2. The ceramic body 2 includes a plurality of laminated ceramic layers 3 and a plurality of inner electrodes 4 and 5 disposed along interfaces between the plurality of ceramic layers 3. The inner electrodes 4 and 5 include first inner electrodes 4 and second inner electrodes 5 that are alternately arranged in the laminating direction of the ceramic body 2. A first outer electrode 6 and a second outer electrode 7 that are made of an electroconductive film are disposed on the surface of the ceramic body 2, more specifically on respective opposing end surfaces. The first outer electrode 6 is electrically connected to the first inner electrodes 4, and the second outer electrode 7 is electrically connected to the second inner electrodes 5.

The ceramic layers 3 are made, for example, of a dielectric ceramic including ABO₃ (wherein A is at least one of Ba, Ca, or Sr, and B is at least one of Ti or Zr) as a main component. The dielectric ceramic including ABO₃ as a main component may further include, for example, at least one of Mn, Mg, Si, Y, Dy, or Gd as a subcomponent.

Preferably, the inner electrodes 4 and 5 include, as an electroconductive component, an electroconductive metal or an alloy including the electroconductive metal such as at least one of nickel, copper, silver, or a silver/palladium alloy.

The outer electrodes 6 and 7 are formed by applying the electroconductive material according to an example embodiment of the present invention to end surfaces of the ceramic body 2 such that the electroconductive material comes into contact with end portions of the inner electrodes 4 and 5, then heat-drying the applied electroconductive material, and firing the resulting electroconductive material.

The multilayer ceramic capacitor 1 is produced, for example, through the following steps. First, a ceramic slurry including a ceramic raw material powder having the composition described above is produced. Next, an appropriate sheet forming method is used to form the ceramic slurry into ceramic green sheets. Next, an electroconductive paste that later becomes the inner electrodes 4 and 5 is applied by, for example, printing to prescribed ones of the plurality of ceramic green sheets. Next, the plurality of ceramic green sheets are laminated and then pressure-bonded to obtain a green ceramic body. Next, the green ceramic body is fired. Through the firing step, the ceramic green sheets become the ceramic layers 3. Then the step of forming the outer electrodes 6 and 7 on end surfaces of the ceramic body 2 is performed.

The electroconductive material for forming the outer electrodes 6 and 7 includes CuO nanoparticles that, when fired, becomes metallic copper defining and functioning as an electroconductive component, a glass raw material mixture that becomes glass when fired, and a solvent that dissolves or disperses the CuO nanoparticles and the glass raw material mixture, and that the glass raw material mixture includes a metal salt that is to be heated above its melting point during firing and is configured as a powder having a particle diameter of, for example, about 100 nm or less or as ions.

The above-described electroconductive material is initially in a sol state. The electroconductive material is applied to the surface of the ceramic body 2, more specifically to its opposing end surfaces, and then heat-dried, and the sol state is thus converted to a gel state. The resulting electroconductive material is fired at a temperature higher than or equal to the melting point of the metal salt included in the glass raw material mixture, and the glass raw material mixture is thus caused to flow and vitrify.

FIG. 2 is an enlarged cross-sectional view schematically illustrating a portion of the first outer electrode 6 of the multilayer ceramic capacitor 1 shown in FIG. 1. Although not illustrated in FIG. 2, the second outer electrode 7 has the same or substantially the same structure as the first outer electrode 6.

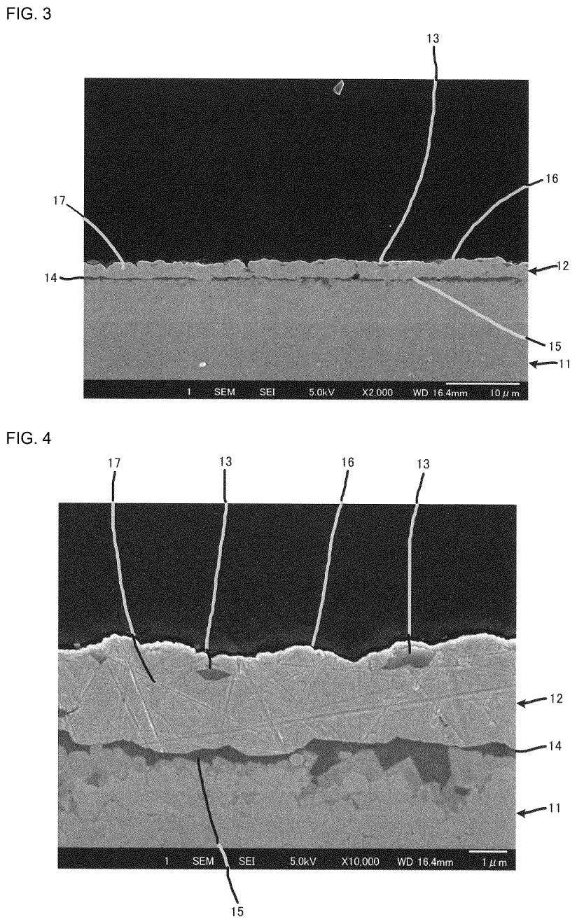

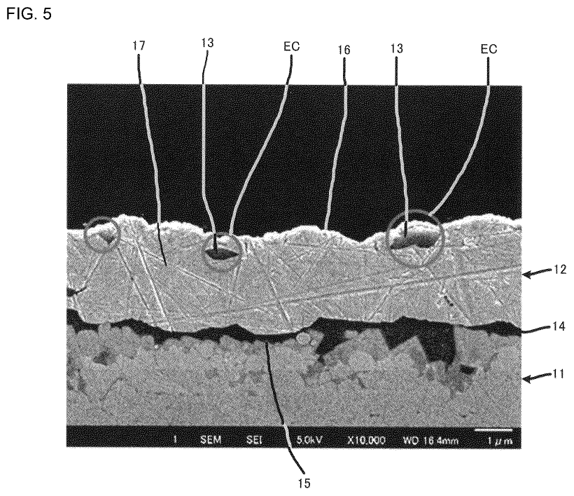

FIGS. 3 to 5 show SEM images of a cross section of an electroconductive film 12 provided on a substrate 11 in Experimental Examples described later. The structure of this electroconductive film 12 is used for the outer electrodes 6 and 7, and therefore FIGS. 3 to 5 may be referred to in the following description. FIG. 4 shows an enlarged SEM image of a portion of the electroconductive film 12 shown in FIG. 3, and FIG. 5 is an image in which circles EC circumscribing glass domains 13 are added to the SEM image shown in FIG. 4.

As a result of the firing described above, a glass layer 14 is formed along the interfaces at which the outer electrodes 6 and 7 are in contact with the ceramic layers 3 of the ceramic body 2, as shown in FIG. 2 for the first outer electrode 6. In FIGS. 3 to 5, portions extending along the interface at which the substrate 11 is in contact with the electroconductive film 12 are the glass layer 14. In FIGS. 3 to 5, the glass layer 14 appears as blackish portions.

Referring to FIG. 2, the glass layer 14 provides a firm joint state between the ceramic body 2 and the copper included in the outer electrodes 6 and 7. Since the firing temperature is higher than or equal to the melting point of the metal salt included in the glass raw material mixture as described above, an underlayer surface 15 can be easily wetted with the glass included in the outer electrodes 6 and 7, and the densification of the glass is facilitated.

In the SEM images in FIGS. 3 to 5, a plurality of glass domains 13, which appear as darker regions, are present in the electroconductive film 12. In the cross section of the electroconductive film 12 in the thickness direction, these glass domains 13 are not in contact with the surface 16 of the electroconductive film 12 and with the underlayer surface 15 and are surrounded by copper 17. The glass domains 13 are not mixed with the copper 17 and are distributed as small-size domains.

The above structure will be described with reference to FIG. 2, with the electroconductive film 12 replaced by the outer electrodes 6 and 7. In the cross sections of the outer electrodes 6 and 7 in the thickness direction, a plurality of glass domains made of glass, surrounded by copper, and not in contact with the surface 16 and the underlayer surface 15 in the cross section are present in the outer electrodes 6 and 7. These glass domains are not mixed with copper and are distributed as small-size domains.

To specify this structure more clearly, the concept of circles EC circumscribing the glass domains 13 is introduced as shown in FIG. 5, and this concept is quantified as follows. Specifically, the average of the diameters of the circumscribed circles EC is, for example, about 0.5 μm or more and about 0.7 μm or less. The standard deviation of the diameters of the circumscribed circles EC is, for example, about 0.3 μm or more and about 0.5 μm or less, and the ratio of the maximum diameter of the circumscribed circles EC to the dimension of the outer electrodes 6 and 7 in the thickness direction is, for example, less than about 1.

As shown in FIG. 2 for the first outer electrode 6, a plating film 8 is optionally provided on the outer electrodes 6 and 7. Although the details of the plating film 8 are not illustrated, the plating film 8 includes, for example, a Cu plating layer, a Ni plating later thereon, and a Sn plating layer thereon.

In this manner, even when the electroconductive material that becomes the outer electrodes 6 and 7 is fired until the copper portions and the ceramic body 2 are joined through the glass layer 14, the glass domains 13 can be maintained as uniform small-size domains. Therefore, glass domains that pierce the outer electrodes 6 and 7 so as to extend from the surface 16 to the underlayer surface 15 are unlikely to be formed. In this case, intrusion of moisture from glass portions on the surfaces of the outer electrodes 6 and 7 can be reduced. Moreover, the glass is not exposed significantly at the surfaces of the outer electrodes 6 and 7, and good plating adhesion is obtained.

The reason that the outer electrodes 6 and 7 obtained have the advantages described above may be that the electroconductive material according to an example embodiment of the present invention is used and fired according to the production method according to an example embodiment of the present invention. This is because of the following reasons. The electroconductive material includes the CuO nanoparticles as the electroconductive component and further includes the metal salt as a particle with a particle diameter of, for example, about 100 nm or less or as ions in the glass raw material mixture. Therefore, even when firing is performed at a temperature higher than or equal to the melting point of the glass raw material mixture to fuse the glass particles together, the glass domains can be maintained as uniform small-size domains.

Another feature of the electroconductive material according to an example embodiment of the present invention is that a thin electroconductive film can be formed. For example, the dimension of the outer electrodes 6 and 7 in the thickness direction can be about 2.4 μm or more and about 4.6 μm or less, as can be seen from Experimental Examples described later.

The metal salt included in the glass raw material mixture included in the electroconductive material for the outer electrodes 6 and 7 includes, for example, at least one of a metal carboxylate and a metal nitrate.

The glass included in the outer electrodes 6 and 7 includes, for example, SiO₂ and B₂O₃ and further includes, for example, an oxide of at least one of an alkali metal and an alkaline-earth metal.

The ratio of the weight of the glass raw material mixture to the weight of the CuO nanoparticles defining and functioning as the electroconductive component included in the electroconductive material for the outer electrodes 6 and 7 is, for example, preferably about 0.13 or more and about 0.57 or less in a ratio of the weight of the glass after conversion from the glass raw material mixture to the weight of the metallic copper after conversion from the CuO nanoparticles.

The electroconductive material for the outer electrodes 6 and 7 may include an organic binder in order to adjust viscosity etc. For example, hydroxypropyl cellulose is advantageously used as the organic binder.

Example embodiments of the present invention have been described in relation to the outer electrodes of the multilayer ceramic capacitor. However, example embodiments of the present invention are applicable to any ceramic electronic component other than the multilayer ceramic capacitor as long as it includes a ceramic body and an electroconductive film disposed on the surface of the ceramic body.

Next, Experimental Examples provided to examine the advantageous effects of example embodiments of the present invention will be described.

### EXAMPLE

### Production of Electroconductive Material

An electroconductive material in a sol state including the following (1) to (7) was produced.
(1) Nano-silica having a diameter of 50 nm and surface-treated with methacrylic silane (“ADMANANO” manufactured by Admatechs Company Limited): about 1.5% by mass.
(2) Boric acid: about 0.92% by mass.
(3) Lithium nitrate (melting point: about 260° C.): about 0.48% by mass.
(4) Sodium nitrate (melting point: 306° C.): 0.66% by mass.
(5) CuO nanoparticles with a diameter of about 50 nm: about 27.60% by mass.
(6) Hydroxypropyl cellulose (about 2.0 to about 2.9 @ about 20° C./2% aqueous solution): about 11.60% by mass.
(7) Diethylene glycol monoethyl ether: about 43.80% by mass.

(1) to (4) above are used as a glass raw material that becomes glass when fired. (5) is CuO nanoparticles that become metallic copper defining and functioning as the electroconductive component when fired. (6) is an organic binder. (7) is a solvent.

### Application-Firing

A doctor blade with a clearance of about 50 μm was used to apply the electroconductive material to a barium titanate substrate. Then the electroconductive material was dried at 150° C. for about 30 minutes to convert the sol state of the electroconductive material to a gel state. Next, the electroconductive material in the gel state was fired in a N₂ atmosphere at a temperature of about 780° C., which is higher than or equal to the melting points of (3) and (4) above, to thus obtain an electroconductive film sample.

### Structural Analysis of Electroconductive Film

The electroconductive film sample was embedded in a resin and polished to obtain a cross section. Then the cross section was observed under an FE-SEM (JSM-6335F manufactured by JEOL Ltd.) under the following conditions.
Treatment before observation: Au+Pd sputtering.
Magnification: about 2000×.
Acceleration voltage: about 5 kV.
WD: about 15 mm to about 18 mm.

FIG. 3 is an SEM image of the cross section of the electroconductive film 12 sample in the Example. FIG. 4 is an enlarged SEM image of a portion of the electroconductive film 12 shown in FIG. 3.

In FIGS. 3 and 4, blackish portions in the electroconductive film 12 that extend along the substrate 11 are the glass layer 14. As can be seen from FIG. 3, in a region larger than or equal to about one half of the obtained image in the width direction, the glass layer 14 is formed so as to spread out between the electroconductive film 12 and the substrate 11.

Next, image analysis software (WinROOF2021 manufactured by MITANI CORPORATION) was used to measure the film thickness of the electroconductive film 12 in the obtained image, and circles EC circumscribing glass domains 13 surrounded by copper 17 and not in contact with the surface 16 and the underlayer surface 15 in the cross section of the electroconductive film 12, i.e., the fired film, were drawn, as shown in FIG. 5. The maximum diameter of the circumscribed circles EC drawn, their average diameter, and the standard deviation of the diameters were determined, and the maximum diameter/the film thickness was computed. These operations performed on one viewing field were repeated on a total of six viewing fields. The results are shown in Table 1.

TABLE 1

| | First | Second | Third | Fourth | Fifth | Sixth |
|---|---|---|---|---|---|---|
| | viewing | viewing | viewing | viewing | viewing | viewing |
| | field | field | field | field | field | field |
| Maximum | 1.48 | 1.15 | 1.33 | 2.03 | 1.28 | 1.16 |
| diameter | | | | | | |
| (μm) | | | | | | |
| Average | 0.54 | 0.52 | 0.53 | 0.74 | 0.73 | 0.66 |
| diameter | | | | | | |
| (μm) | | | | | | |
| Standard | 0.35 | 0.26 | 0.30 | 0.45 | 0.38 | 0.28 |
| deviation | | | | | | |
| (μm) | | | | | | |
| Film | 4.1 | 4.58 | 2.39 | 3.43 | 2.63 | 2.77 |
| thickness | | | | | | |
| (μm) | | | | | | |
| Maximum | 0.4 | 0.3 | 0.6 | 0.6 | 0.5 | 0.4 |
| diameter/ | | | | | | |
| film thickness | | | | | | |

### COMPARATIVE EXAMPLE

### Production of Electroconductive Material

A roll mill was used to produce an electroconductive material having the following composition.
Cu powder (average particle diameter: about 4 μm, flake-like powder): about 100 parts by mass.
Glass powder (average particle diameter: about 3.3 μm): about 10 parts by mass.
Vehicle obtained by dissolving an acrylic resin-based binder in terpineol: about 40 parts by mass.

### Application-Firing

The electroconductive material was applied in the same or substantially the same manner as in the Example and then fired in a N₂ atmosphere with an oxygen concentration of about 5 ppm at a temperature of about 860° C. to obtain an electroconductive film sample.

### Structural Analysis of Electroconductive Film

The structural analysis of the electroconductive film sample was performed in the same or substantially the same manner as in the Example.

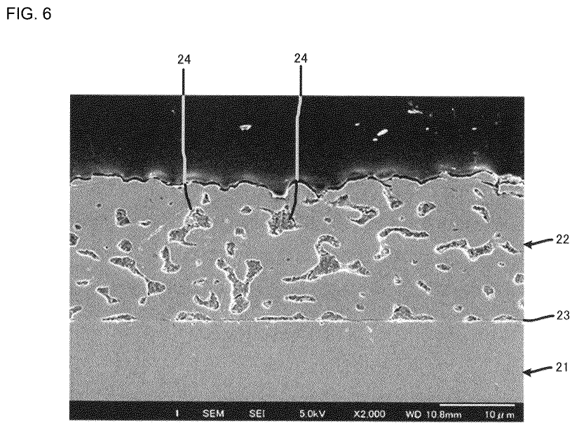

FIG. 6 is an SEM image of a cross section of the electroconductive film 22 sample in the Comparative Example.

In FIG. 6, blackish portions in the electroconductive film 22 that extend along a substrate 21 are a glass layer 23. As can be seen from FIG. 6, in a region larger than or equal to about one half of the obtained image in the width direction, the glass layer 23 is formed so as to spread out between the electroconductive film 22 and the substrate 21.

The maximum diameter of circles circumscribing glass domains 24, the average of their diameters, and the standard deviation of the diameters were determined in the same manner as in the Example, and the film thickness was also determined. Then the maximum diameter/the film thickness was computed. The results are shown in Table 2.

TABLE 2

| | First | Second | Third | Fourth | Fifth | Sixth |
|---|---|---|---|---|---|---|
| | viewing | viewing | viewing | viewing | viewing | viewing |
| | field | field | field | field | field | field |
| Maximum | 5.34 | 5.34 | 16.0 | 8.57 | 9.7 | 7.84 |
| diameter | | | | | | |
| (μm) | | | | | | |
| Average | 2.25 | 2.04 | 3.04 | 1.88 | 2.86 | 2.63 |
| diameter | | | | | | |
| (μm) | | | | | | |
| Standard | 1.36 | 1.34 | 3.83 | 1.54 | 2.45 | 1.57 |
| deviation | | | | | | |
| (μm) | | | | | | |
| Film | 17.03 | 12.5 | 14.51 | 14.08 | 20.33 | 17.37 |
| thickness | | | | | | |
| (μm) | | | | | | |
| Maximum | 0.3 | 0.4 | 1.1 | 0.6 | 0.5 | 0.5 |
| diameter/ | | | | | | |
| film thickness | | | | | | |

Table 3 below compares the ranges of the numerical values of the maximum diameter of the circles EC circumscribing the glass domains 13, the average diameter, the standard deviation, the film thickness, and the maximum diameter/the film thickness in the Example shown in Table 1 with the ranges of the numerical values of the maximum diameter of the circles circumscribing the glass domains 24, the average diameter, the standard deviation, the film thickness, and the maximum diameter/the film thickness in the Comparative Example show in Table 2. In Table 3, each value shown is rounded to the first decimal place.

TABLE 3

| | Example | Comparative Example |
|---|---|---|
| Maximum diameter (μm) | 1.2 to 2.0 | 5.3 to 16.0 |
| Average diameter (μm) | 0.5 to 0.7 | 1.9 to 3.0 |
| Standard deviation (μm) | 0.3 to 0.5 | 1.3 to 3.8 |
| Film thickness (μm) | 2.4 to 4.6 | 12.5 to 20.3 |
| Maximum diameter/film | 0.3 to 0.6 | 0.3 to 1.1 |
| thickness | | |

The film thicknesses in Table 3 are first compared. The thickness is about 2.4 μm or more and about 4.6 μm or less in the Example and is about 12.5 μm or more and about 20.3 μm or less in the Comparative Example. As can be seen, the film thickness can be much smaller in the Example than in the Comparative Example. This can also be seen by comparing FIG. 3 with FIG. 6 that are shown with the same scale.

As shown in Table 3, in the Example, the average diameter, in particular, is about 0.5 μm to about 0.7 μm, and the standard deviation is about 0.3 μm to about 0.5 μm. In the Comparative Example, the average diameter is about 1.9 μm to about 3.0 μm, and the standard deviation is about 1.3 μm to about 3.8 μm. This shows that the glass domains 13 are smaller in the Example and their sizes are more uniform.

In the Example, the maximum diameter/the film thickness is about 0.3 to about 0.6, which is less than 1. Therefore, in this state, it can be judged that glass domains piercing the electroconductive film 12 so as to extend from the surface 16 to the underlayer surface 15 are unlikely to be formed.

In the Comparative Example, the average diameter of the circles circumscribing the glass domains is about 1.9 μm to about 3.0 μm, and the standard deviation is about 1.3 μm to about 3.8 μm. As can be seen, the glass domains are larger and less uniform as compared to the results in the Example.

In the Comparative Example, the maximum diameter/the film thickness is about 0.3 to about 1.1 and is about 1 or more in one viewing field. Therefore, it can be judged that glass domains piercing the electroconductive film 22 so as to extend from its surface to the underlayer surface are likely to be formed.

As can be seen from above, in the Comparative Example, the CuO particles and the glass raw material particles in the electroconductive material are large. It is therefore inferred that, when the firing is continued until Cu and the substrate 21 are joined together, the glass particles are fused and the size of the glass domains increases. It is therefore inferred that glass domains piercing the electroconductive film 22 so as to extend from its surface to the underlayer surface are formed and intrusion of a plating solution into the electroconductive film 22 occurs. It is also inferred that, on the surface of the electroconductive film 22 also, the size of the glass domains is large and plating adhesion thus deteriorates.

However, in the Example, the Cu in the electroconductive material is provided as the CuO nanoparticles, and the glass raw material mixture includes the metal salt as a powder with a particle diameter of about 100 nm or less or as ions. In this case, even when the glass particles are fused together, the glass domains 13 can be maintained as uniform small-size domains. Therefore, the formation of glass domains piercing the electroconductive film 12 so as to extend from its surface 16 to the underlayer surface 15 is reduced or prevented, and the intrusion of the plating solution into the electroconductive film 12 can be reduced or prevented. Moreover, the glass is not exposed significantly at the surface 16 of the electroconductive film 12, so that good plating adhesion can be obtained.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electroconductive material to form an electroconductive film on a surface of a ceramic body by firing, the electroconductive material comprising:
CuO nanoparticles that, when fired, become metallic copper defining and functioning as an electroconductive component;
a glass raw material mixture that becomes glass when fired; and
a solvent to dissolve or disperse the CuO nanoparticles and the glass raw material mixture; wherein
the glass raw material mixture includes a metal salt configured as a powder with a particle diameter of about 100 nm or less or as ions.

2. The electroconductive material according to claim 1, wherein the metal salt includes at least one of a metal carboxylate and a metal nitrate.

3. The electroconductive material according to claim 1, wherein the electroconductive material defines an outer electrode of a multilayer ceramic capacitor.

4. The electroconductive material according to claim 1, wherein a ratio of a weight of the glass raw material mixture to a weight of the CuO nanoparticles is about 0.13 or more and about 0.57 or less as a ratio of a weight of the glass after conversion from the glass raw material mixture to a weight of the metallic copper after conversion from the CuO nanoparticles.

5. The electroconductive material according to claim 1, wherein the solvent includes diethylene glycol monoethyl ether.

6. The electroconductive material according to claim 1, further comprising an organic binder.

7. The electroconductive material according to claim 6, wherein the organic binder includes hydroxypropyl cellulose.

8. A method for producing a ceramic electronic component including a ceramic body and an electroconductive film on a surface of the ceramic body, the method comprising:
applying the electroconductive material according to claim 1 to the surface of the ceramic body to form the electroconductive film;
heat-drying the glass raw material mixture included in the electroconductive material; and
performing firing at a temperature higher than or equal to a melting point of the glass raw material mixture to form the electroconductive film.

9. The method according to claim 8, wherein the metal salt includes at least one of a metal carboxylate and a metal nitrate.

10. The method according to claim 8, wherein the electroconductive material defines an outer electrode of a multilayer ceramic capacitor.

11. The method according to claim 8, wherein a ratio of a weight of the glass raw material mixture to a weight of the CuO nanoparticles is about 0.13 or more and about 0.57 or less as a ratio of a weight of the glass after conversion from the glass raw material mixture to a weight of the metallic copper after conversion from the CuO nanoparticles.

12. The method according to claim 8, wherein the solvent includes diethylene glycol monoethyl ether.

13. A ceramic electronic component comprising:
a ceramic body; and
an electroconductive film on a surface of the ceramic body; wherein
the electroconductive film includes copper and glass;
in a cross section of the electroconductive film in a thickness direction thereof, a plurality of glass domains including the glass, surrounded by the copper, and not in contact with a surface and an underlayer surface in the cross section are provided;
an average of diameters of circles circumscribing the glass domains is about 0.5 μm or more and about 0.7 μm or less;
a standard deviation of the diameters of the circles is about 0.3 μm or more and about 0.5 μm or less; and
a ratio of a maximum diameter of the circles to a dimension of the electroconductive film in the thickness direction thereof is less than about 1.

14. The ceramic electronic component according to claim 13, wherein the dimension of the electroconductive film in the thickness direction thereof is about 2.4 μm or more and about 4.6 μm or less.

15. The ceramic electronic component according to claim 13, wherein the glass includes SiO₂ and B₂O₃ and further includes an oxide of at least one of an alkali metal and an alkaline-earth metal.

16. The ceramic electronic component according to claim 13, further comprising a plating film on the electroconductive film.

17. The ceramic electronic component according to claim 13, wherein
the ceramic body includes a plurality of laminated ceramic layers and a plurality of inner electrodes along a plurality of interfaces between the plurality of ceramic layers;
the electroconductive film defines and functions as a plurality of outer electrodes on the surface of the ceramic body and electrically connected to the inner electrodes; and
the ceramic electronic component defines a multilayer ceramic capacitor.

18. The ceramic electronic component according to claim 17, wherein each of the plurality of ceramic layers includes ABO₃, wherein A includes at least one of Ba, Ca, or Sr, and B includes at least one of Ti or Zr as a main component.

19. The ceramic electronic component according to claim 18, wherein each of the plurality of ceramic layers includes at least one of Mn, Mg, Si, Y, Dy, or Gd as a subcomponent.

20. The ceramic electronic component according to claim 17, wherein each of the plurality of inner electrodes includes at least one of nickel, copper, silver, or a silver/palladium alloy.
